(19) United States
(12) Patent Application Publication
(10) Pub. No.: US 2019/0026788 A1
(43) Pub. Date: Jan. 24, 2019

(54) DIGITAL SIGNAGE CONTENT CURATION BASED ON SOCIAL MEDIA

(71) Applicant: SPRINKLR, INC., New York, NY (US)

(72) Inventors: Justin Trevor GARRITY, Portland, OR (US); Ryan Robert PARR, North Plains, OR (US)

(21) Appl. No.: 16/122,544

(22) Filed: Sep. 5, 2018

Related U.S. Application Data
(63) Continuation-in-part of application No. 15/160,694, filed on May 20, 2016.
Application No. 15/160,694 is a continuation-in-part of application No. 14/997,013, filed on Jan. 15, 2016.
(60) Provisional application No. 62/165,479, filed on May 22, 2015.
(60) Provisional application No. 62/107,285, filed on Jan. 23, 2015.

(51) Int. Cl. G06Q 30/02; G06Q 50/00

(52) U.S. Cl. CPC G06Q 30/0276; G06Q 30/0263; G06Q 30/0254; G06Q 50/01

(57) ABSTRACT

A processing system uses a set of rules that identify a set of keywords and stores a set of creative images associated with the keywords. The processing system identifies metrics for the social media that includes the keywords and displays the creative images associated with the keywords with the largest social media metrics. The set of rules may include promotions to display with the creative content and filters that determine what social media to use to generate the metrics. No manual curation of content is necessary. The processing system saves time and effort as well as taps into real time consumer trends.

### CROSS-REFERENCE TO RELATED APPLICATION

This application is a continuation-in-part of U.S. patent application Ser. No. 15/160,694, entitled: SOCIAL MEDIA ENHANCEMENT, filed May 20, 2016, which claims priority to U.S. Provisional Application No. 62/165,479, filed May 22, 2015, the entire disclosures of each are incorporated herein by reference. This application is also a continuation-in-part of U.S. patent application Ser. No. 14/997,013, entitled: MULTI-DIMENSIONAL COMMAND CENTER, filed Jan. 15, 2016, which claims priority to U.S. Provisional Application No. 62/107,285, filed Jan. 23, 2015, the entire disclosures of each are also incorporated herein by reference.

### BACKGROUND

Digital signage is used in many different businesses. The digital sign may display different creative featuring products, services, advertisements, promotions, and/or interstitials associated with the businesses. For example, a digital sign at a fast food restaurant may continuously display creative featuring different products sold by the restaurant. The creative displayed on digital signage screens are often scheduled manually weeks or months in advance across multiple locations and regions. Therefore, the digital sign operator is left to speculate far in advance of what displayed content may be most interesting to customers across large regions of store locations.

### BRIEF DESCRIPTION OF THE DRAWINGS

FIG. 1 depicts an example social media processing system.

FIG. 2 depicts example enhancements added to different posts.

FIG. 3 depicts additional example enhancements added to posts.

FIG. 4 depicts an example process for the social media processing system of FIG. 1.

FIG. 5 depicts an example process for enhancing posts.

FIG. 6 depicts an example process for enhancing posts associated with an event.

FIG. 7 depicts an example processing system that displays creative based on social media metrics.

FIG. 8A depicts another example processing system that displays creative for different products based on social media metrics in different geographical locations.

FIG. 8B depicts another example processing system that displays creative for different versions of a product based on social media metrics.

FIG. 9 depicts an example processing system that displays promotions based on social media metrics.

FIG. 10 depicts an example user interface that is used to generate rules for the processing system.

FIG. 11 depicts an example process for displaying content based on social media metrics.

FIG. 12 depicts example rules used by the processing system to display creative.

FIG. 13A depicts another example of how the processing system may display creative based on social media metrics.

FIG. 13B depicts another example of how the processing system may overlay creative for different subjects based on social media metrics for the different subjects.

FIG. 14 depicts another example of how the processing system may display creative for different combinations of items based on social media metrics.

FIG. 15 depicts an example computing device used in the processing system.

### DETAILED DESCRIPTION

Manual content curation can miss what might be the most effective or most popular content, specifically as certain topics begin to trend in real time. A processing system dynamically determines which creative to display on digital signage based on trends emerging in social media data. The social media contains specific conversations regarding a brand and associated products. Social media monitoring is set up by an operator by creating topics, which are queries, that are used to fetch data from social media networks. Once stored, segments of the data that align to the brand, like features of a newly released product, can be analyzed.

Once this segmentation is set up, results are used to determine which prepared creative content to feature on digital signage for the brand. For instance, if the brand is a fast food restaurant, a digital sign facing the street may promote the most popular breakfast items in the morning and the most popular sandwiches at lunch and dinner without any manual curation by the brand. This solution may determine which creative ads or promotions to dynamically feature. No manual curation of what content to feature is necessary. The processing system saves time and effort as well as taps into real time consumer trends.

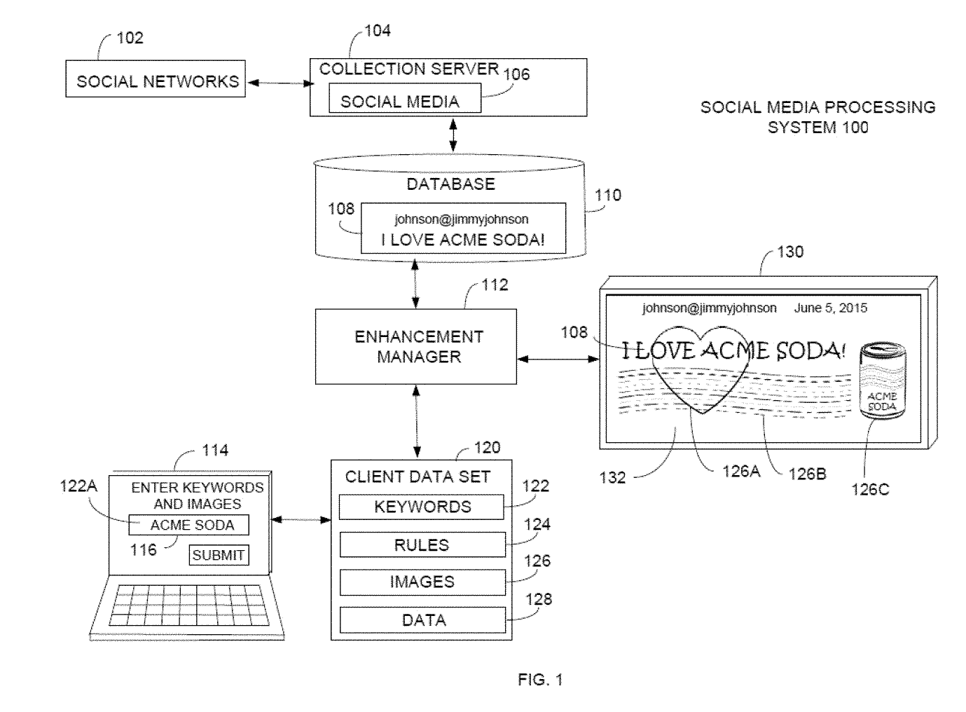

FIG. 1 shows an example social media processing system (processing system) 100. A collection server 104 accesses different social networks 102, such as Twitter®, Facebook®, Instagram®, Google®, or any other website associated with a company, individual, or any other entity. Collection server 104 collects and stores social media 106 from social networks 102 in database 110. Social media 106 may include messages, tweets, pictures, images, audio, video, text, posts, or any other data.

A data set 120 may include any combination of keywords 122, rules 124, images 126, or any other data 128. A user may create data set 120 via a user device 114, such as a portable notebook, portable tablet, or personal computer 102. The user may create a data set associated with a particular company. For example, the user may add a keyword 122A such as Acme Soda into a field 116 displayed on the screen of user device 114.

The user may enter and associate one or more rules 124, images 126, and/or any other data 128 with keywords 122. For example, the client may create a rule 124 that associates the keyword Acme Soda with an Acme Soda logo 126B and an image of an Acme Soda can 126C.

An enhancement manager 112 may operate in an application server within processing system 100 and enhance social media 106 based on data set 120. Enhancement manager 112 may identify social streams in social media 106 associated with the Acme Company. For example, enhancement manager 112 may identify messages within social media 106 sent to a @Acme social network account or that include a #Acme hashtag.

Enhancement manager 112 may curate the identified messages for rendering on a display screen 130. For example, enhancement manager 112 may filter out derogatory or obscene messages and/or identify messages with positive comments regarding Acme Soda.

In one example, enhancement manager 112 identifies a message 108 that includes the text: I LOVE ACME SODA. Enhancement manager 112 compares the words in message 108 with keywords 122 in data set 120. In this example, the term Acme Soda in message 108A matches keyword 122A in data set 120. Enhancement manager 120 identifies images 126B and 126C in data set 120 specified by rules 124 associated with the matching keyword 122A. Enhancement manager 112 adds images 126B and 126C as enhancements to message 108 and displays both as enhanced post 132 on display screen 130.

Data set 120 may associate other keywords 122 with other images 126. For example, the user may associate another image 126A in data set 120 with the keyword LOVE. Enhancement manager 112 then may identify the additional word LOVE in message 108 and add the associated image 126A prior to rendering enhanced message 132 on display screen 130.

Enhancement manager 112 may add other data 128 from data set 120 to message 108, such as a price of the product and/or a location for purchasing the product mentioned in message 108. Data 128 in data set 120 also may identify different fonts and font sizes for associated keywords 122. For example, data 128 may identify a font used on Acme Soda cans. Enhancement manager 112 may further enhance message 108 by changing the font originally used in message 108 to the font used on Acme soda cans.

Enhancement manager 112 also may identify images contained in message 108. For example, a user may post a message that includes a company logo. Data set 120 may include the logo as part of keywords 122 and enhancement manager 112 may use an image detection system to detect any messages 108 that contain the logo. Enhancement manager 112 then may include a rule and associated images and/or data for adding to message 108 based on the detected logo.

Enhancements 126 increase the visual connection of a product mentioned in post 108 with viewers. For example, logo 126B and soda can 126C immediately connect viewers with Acme Soda. In addition, heart image 126A immediately notifies viewers that message 108 is a positive endorsement of Acme Soda. Thus, enhanced message 132 combines the increased visual impact and viewer association of images 126 with the user endorsement contained in message 108.

The same or different data sets 120 may include different keywords 122, rules 124, images 126, and data 128 for different products, services, and events. For example, a first set of keywords 122, rules 124, and images 126 may be associated with a first type of soda and a second set of keywords 122, rules 124, and images 126 may be associated with a second type of soda. A third set of keywords 122, rules 124, and images 126 may be associated with a particular campaign or event associated with Acme Soda, such as an athletic event or concert.

Processing system 100 may associated different data sets 120 with different clients. For example, a first dataset 120 may contain the keywords, rules, image and/or data for a clothes manufacturer and a second dataset 120 may contain the keywords, rules, image and/or data for a movie studio. Users via user device 114 or datasets 120 may identify which social media streams for applying to different data sets 120.

In another example, processing system 100 may include multiple display screens 130 and a different data set 120 or group of rules in a same data set 120 may be associated with each display screen. For example, the multiple display screens 130 may be located in a sports stadium and enhancement manager 112 may displayed enhanced messages 132 on each of display screens 130 associated with different players from a sports team.

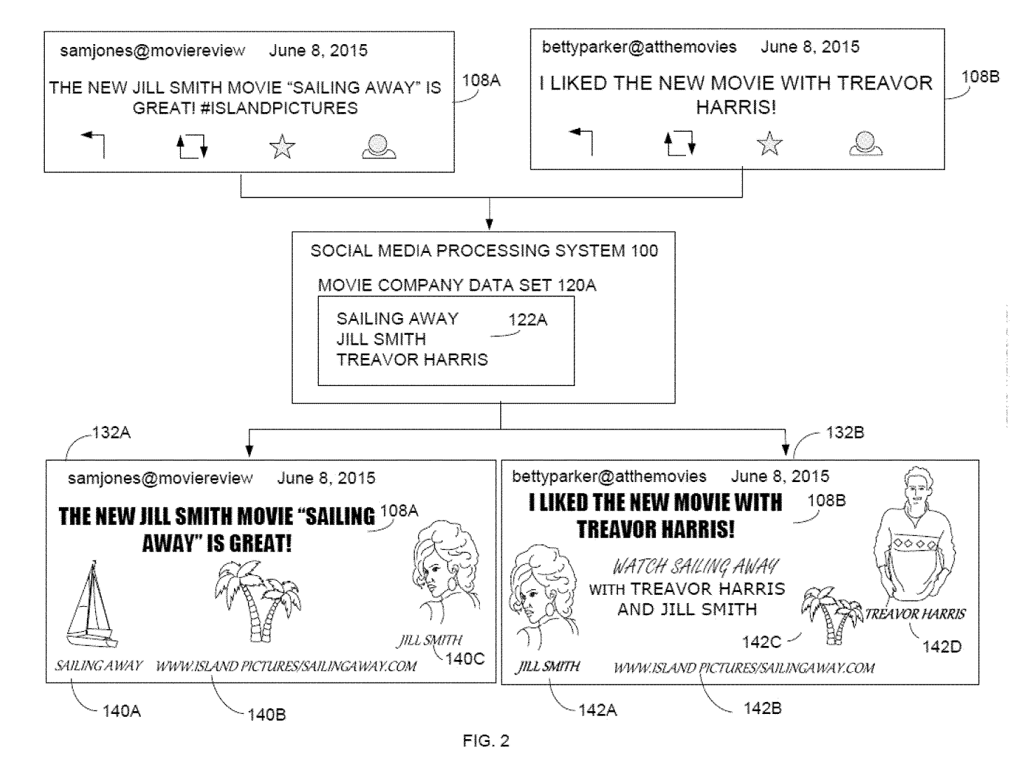

FIG. 2 shows another example of how the processing system may add enhancements to social media. In this example, a movie company may create a data set 120A within social media processing system 100 with keywords and associated rules 122A including the name of a movie and names of actors in the movie. Processing system 100 may collect social media posted on the movie company social network accounts or any other social media that mentions the movie, movie company, actors in the movie, or any other associated context.

In this example, a user may post a message 108A stating: THE NEW JILL SMITH MOVIE “SAILING AWAY” IS GREAT! The user may post message 108A on one of the social media accounts for the movie company that distributes the movie or may have referenced the movie name or movie company name in a hashtag.

Processing system 100 compares keywords 122A with the terms in message 108A and identifies matches for the movie name SAILING AWAY and the actor name JILL SMITH. Data set 120A may include a first rule that directs processing system 100 to add an image 140A from the movie and add an image 140B with the name and logo of the movie company based on the movie name match. The first rule also may specify a particular font to use for message 108A.

Based on the keyword match with actor name JILL SMITH, data set 120A may include a second rule that directs processing system 100 to add image 140C for the actor Jill Smith to message 108A. Thus, resulting enhanced message 132A may have substantially more visual interest than original message 108A.

Processing system 100 may receive another message 108B relating to the same movie including the text: I LIKED THE NEW MOVIE WITH TREAVOR HARRIS! Processing system 100 compares keywords 122A with the terms in message 108B and identifies a match with the actor name Treavor Harris. Data set 120A may include a rule associated with the Treavor Harris keyword 122 that directs processing system 100 to add enhancements 142 to message 108B. In this example, enhancements 142 may include an image 142A of Jill Smith and an image 142D of Treavor Harris.

Enhancements 142 also may include an image 142B of the movie company name and logo. In this example, the rule also may direct processing system 100 to add an advertisement 142C identifying the name of the movie and names of actors in the movie when not already mentioned in message 108B. Thus, processing system 100 may apply different enhancements based on the content in messages 108.

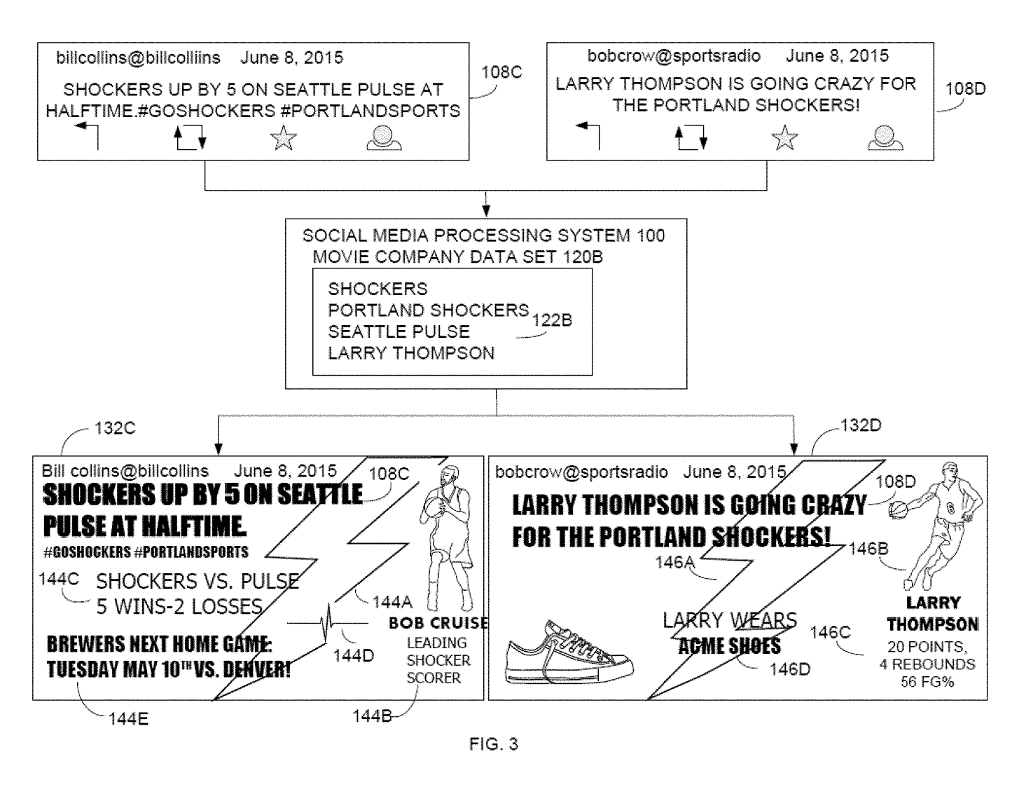

FIG. 3 shows another example of enhancements added to social media. In this example, a sports organization may create a data set 120B in processing system 100 with keywords and associated rules 122B including the name of the basketball team, names of players on the basketball team, and names of other basketball teams. Processing system 100 may collect social media posted on the sports team social network accounts or any other social media that mentions the basketball team, players on the basketball team, other basketball teams, or any other associated context.

In this example, a sports fan may post a message 108C stating: SHOCKERS UP BY 5 ON SEATTLE PULSE AT HALFTIME. Processing system 100 compares keywords 122B with the terms in message 108C and identifies matches both for the sports team Shockers and for another sports team Seattle Pulse that is currently playing the Shockers.

Matches of keywords 122B may include an associated rule that directs processing system 100 to add enhancements 144 to message 108C. Enhancements 144 may include a logo 144A for the basketball team and an image 144B of a leading scorer for the basketball team. Enhancements 144 also may include a picture of Portland that processing system 100 adds as background to message 108C when message 108C also includes the term Portland.

Processing system 100 may receive message 108C during a basketball game with the Seattle Pulse. Based either on the coinciding times of the basketball game and message 108C and/or based on message 108C also mentioning the Seattle Pulse basketball team, a rule in data set 120B may direct processing system 100 to include a current record 144C between the two basketball teams and also may include an image 140D of the opposing team logo.

Data set 120B also may include the current score of the basketball game. In this example, the rule in data set 120B also may display data 144E identifying a next home game for the Portland Shockers. Thus, enhancements 144 provide additional information regarding current and future events associated with the sports team mentioned in message 108C.

Processing system 100 may receive another message 108D stating: LARRY THOMPSON IS GOING CRAZY FOR THE PORTLAND SHOCKERS! Processing system 100 compares keywords 122B with the words in message 108D and identifies a match with the basketball team name Shockers and the basketball player name Larry Thompson. Based on the two matches another rule in data set 122B may direct processing system 100 to add a different set of enhancements 146 to message 108C.

In this example, enhancements 146 may include an image 146A of the team logo, an image 146B of the player mentioned in message 108D, and statistics 146C for the player mentioned in message 108D. Statistics 146C may include statistics of the mentioned player either for the year or for the current basketball game with the Seattle Pulse. Enhancements 146 also may include an advertisement 146D for a product endorsed by the player mentioned in message 108D. Thus, enhancements 146 also provide additional information regarding a specific person mentioned in message 108D.

In another example, different brand names may be associated with different sports. Data set 120B may contain different sport images associated with the different brand names. For example, a first brand name may be associated with basketball and a second band name may be associated with golfing. Data set 120B may include a first keyword 122B for the first brand name that includes an associated image of a basketball player and include a second keyword 122B for the second brand name that includes an associated image of a golfer.

In another example, a user may post a self picture (selfie) with an attached message that mentions a sports figure. Processing system 100 may add a picture of the mentioned sports figure to the posted message.

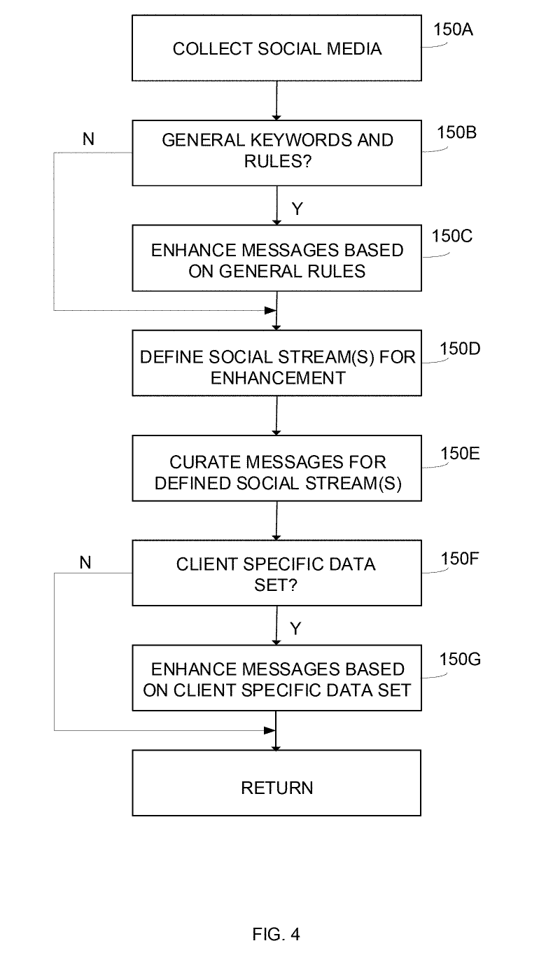

FIG. 4 shows one example process performed by the social media processing system. In operation 150A, the processing system collects social media from different social networks. For example, the processing system may collect messages posted on different accounts on different messaging services, such as Twitter®, Facebook®, Instagram®, Google®, etc.

In operation 150B, the processing system may contain a general set of keywords and rules and add a general set of enhancements to any message with matching terms. For example, the processing system in operation 150C may add the heart image shown in FIG. 1 to any messages that include a positive endorsement term, such like, love, admire, happy, etc.

In operation 150D, the processing system may define different social streams for additional enhancements. For example, an operator may configure the processing system to identify messages posted on particular accounts or that include a particular hashtag.

In operation 150E, the processing system may curate the messages for the defined social streams. For example, an operator, or the enhancement manager 112 in FIG. 1, may select different messages from the social streams for displaying on a display screen.

In operation 150F, the processing system may determine if a second client specific data set exists for applying to the curated messages. For example, a client may create a data set with a specific set of keywords and rules for applying to messages associated with a particular product, event, day, location, or any other criteria.

In operation 150G, the processing system enhances the curated messages based on the client specific data set. For example, the second data set may include a set of rules that direct the processing system to add corporate specific, product specific, location specific, date specific, time specific, and/or event specific enhancements to the messages based on different matching keywords.

The second data set also may have different sets of keyword, rules, and images for different time periods. For example, the second data set may direct the processing device to use a first set of keywords, rules, and images for a first time period and use a second set of keywords, rules, and images for a second time period.

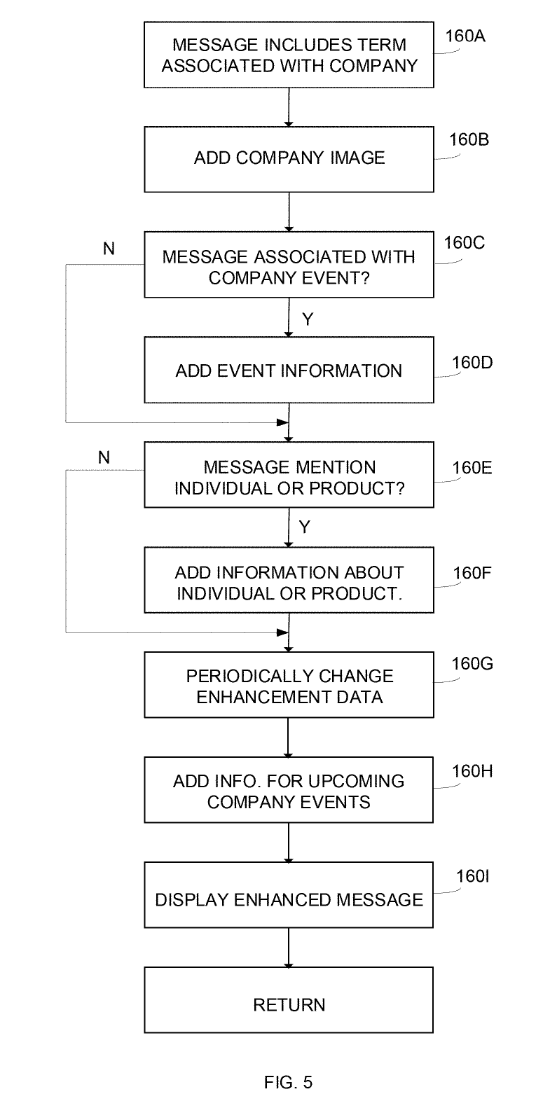

FIG. 5 shows one example set of rules that a data set may use for enhancing social media. This of course is just one example of an almost limitless combination of keywords, rules and images that may be applied to a social media message.

In operation 160A, the processing system may identify a message including a term associated with a company. For example, the message may mention the name of the company or the name of a product sold by the company. In operation 160B, the processing system may add a company image to the message. For example, the processing system may add a company logo or add an image of a company product to the message.

In operation 160C, the processing system may determine if the message is associated with a particular event. For example, the data set may associate a set of keywords with event specific information. The processing system in operation 160D may add event information to any messages associated with the event. For example, processing system may add a picture from the event or add information about the event, such as where and when the event in taking place.

In operation 160E, the message may mention a participant or product associated with the event. For example, the message may mention a speaker at the product launch event or a player in a sporting event. In operation 160F, the processing system may add information to the message about the event participant or product. For example, the processing system may add an image of the speaker and/or add information about the speaker.

In operation 160G, the processing system may periodically change the enhancement data. For example, the data set may have different sets of images associated with the same keywords. To prevent enhanced messages from becoming stale, the data set rules may cause the processing system to use different sets of images for different time periods. For example, a first company logo may be added to messages in the morning and a second company logo, advertisement, and/or image may be added to messages in the afternoon.

In operation 160H, the processing device may add any other information associated with the matching keywords, such as information regarding upcoming events. In operation 160I, the processing device displays the enhanced message on a display screen.

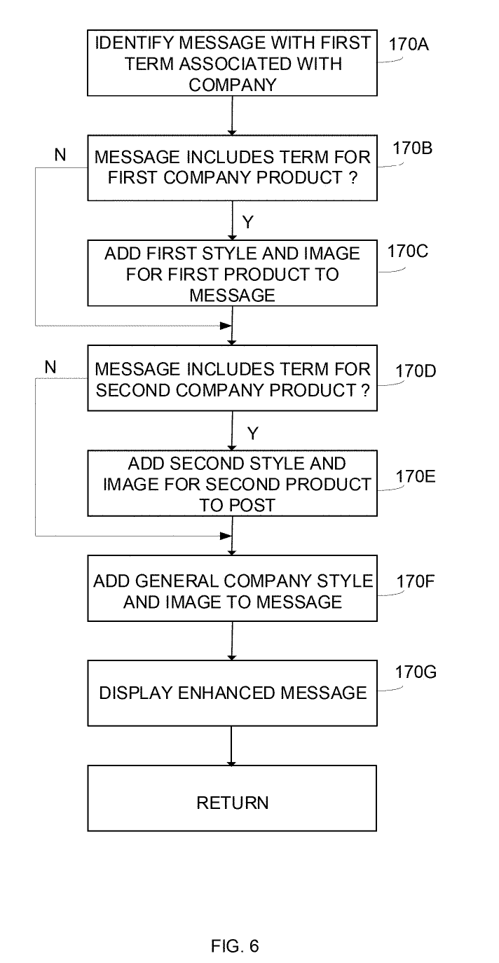

FIG. 6 shows another example of rules that a data set may use to enhance social media. In operation 170A, the processing system may identify a message that contains a first term associated with a particular company, such as the term Acme.

In operation 170B, the processing system may search for a second term associated with a first product sold by the company, such as Diet Acme. If the second term is identified, the processing system in operation 170C may add a first style and image to the message associated with the first product. For example, the processing system may add a silver and black background to the message that corresponds with the colors on an Acme diet soda can and also may add an image of the Acme diet soda can.

In operation 170D, the processing system may search for a term associated with a second product sold by the company, such as Orange Acme. If the third term is identified, the processing system in operation 170E may add a second style and image to the message associated with the second product. For example, the processing system may add a second orange and white background image to the message that corresponds with the colors on Acme orange soda cans and also may include an image of the Acme orange soda can.

In operation 170F, the processing system may add a general company style and image to the message. For example, the processing system may add a general logo or background used on all Acme products. In operation 170G, the processing system then displays the enhanced message on a display device. These of course are just a few examples of rules used by the processing system to enhance social media.

Thus, the enhanced social media may create additional visual connections between viewers and the subject matter referred to in social media messages.

### Digital Signage Curation

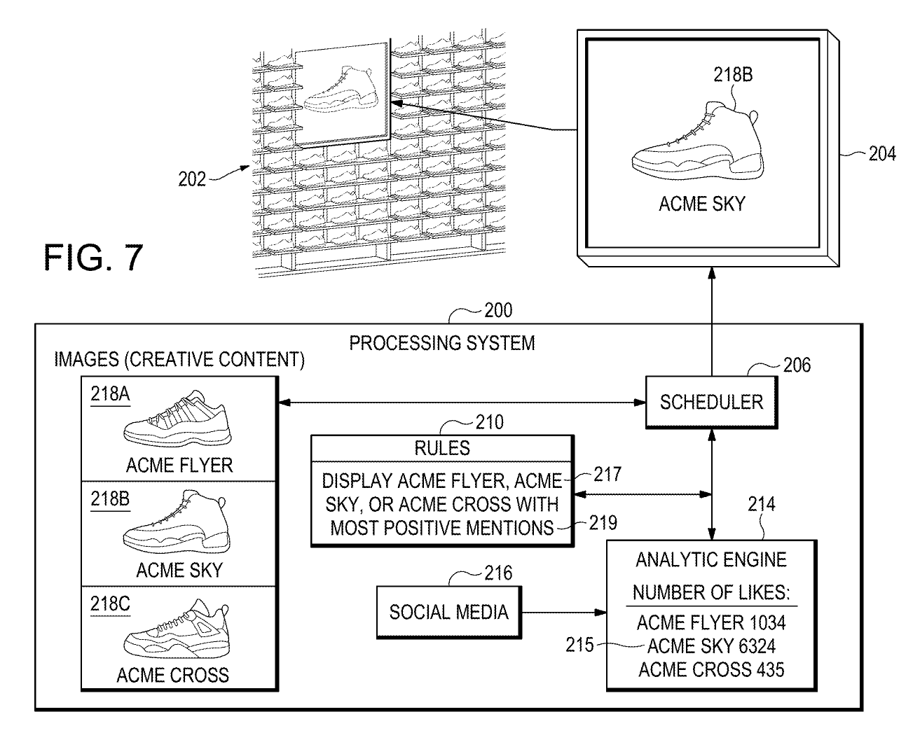

FIG. 7 shows a system that curates creative content for digital signage based on social media. A processing system 200 includes a scheduler 206 that displays different images 218A-218C on a digital sign 204 based on metrics 215 generated by an analytics engine 214 from different social media 216.

In the explanation below, images 218 are alternatively referred to as creative and may refer to any reviewed content that a company may want to use as advertisements for related products. However, image 218 may include any content that a company or any other entity may want to display responsive to social media metrics 216.

Scheduler 206 may receive metrics 215 from analytic engine 214 indicating a most “liked” shoe on social media 216. Social media 216 may indicate the most liked shoe sold by a company Acme, Inc. is the Acme Sky. Accordingly, scheduler 206 may display creative 218B for the Acme Sky shoe in digital sign 204.

Processing system 200 prevents marketers from having to guess which creative 218 to use for advertising different products. For example, prior to a marketing campaign, a company may produce multiple different creative advertisements showing different products, or users of products, that are part of the campaign. The advertiser may manually display different advertisements over different time periods at different locations. However, over time it may be determined that a particular product is not popular with customers and another product is very popular with customers. Unpopular advertisements may not provide much sales or “lift” when displayed in stores.

Instead of manually replacing unpopular creative advertisements, processing system 200 determines in real-time which products are most popular on social media, and then automatically displays the creative advertisements 218 associated with the most popular products.

It should also be understood that processing system 200 may display different creative 218 based on an aggregation of social media 216 positively referring to a product associated with that creative 218. For example, processing system 200 may display one of creative 218 when an associated product has a largest number of positive posts, highest positive sentiment, most positive engagement, largest volume of likes of posts referring to the product, or the like, or any combination thereof.

Processing system 200 may store rules 210 that determine which creative 218 to display on digital sign 204. For example, a rule 210 may include a set of keywords 217 associated with different creative 218. Rule 210 also may include a metric identifier 219 for selecting one of creative 218. For example, keywords 217 may include the names of the three Acme shoes Flyer, Sky, and Cross. Metric identifier 219 may direct scheduler 206 to display one of creative 218 associated with the shoe with the most positive mentions in social media 216.

Scheduler 206 accesses analytic engine 214 to determine which of the three shoes includes the most positive mentions in social media 216. In this example, the Acme Sky shoe has received the most positive mentions over a particular time period. Scheduler 206 then displays creative 218B for the Acme Sky shoe on digital display 204.

Scheduler 206 can dynamically and automatically change which creative 218 is displayed on digital sign 204 based on any real-time changes in social media 216. For example, over time a particular shoe may lose popularity while another shoe may gain in popularity. Scheduler 206 may continuously monitor metrics 215 to identify any changes in shoe popularity and then automatically display creative 218 associated with the latest most popular shoe.

In another example, a particular product may have a largest number of mentions, but the sentiment for that product may be mostly negative. For example, a product recall or an overall negative consumer response to a product may generate a large number of negative mentions on social media 216. Rule 210 may direct scheduler 206 to only display creative 218 associated with the product with the most number of positive mentions. Other rules and metrics are described in more detail below.

Digital sign 204 may be located at a business location, on a website, or at any other point of sale where a customer may purchase a product or service. For example, digital sign 204 may be located in a shoe store 202 in-between or adjacent to racks of shoes. In another example, digital sign 204 may be located above the sales counter at a fast food restaurant. In yet another example, digital sign 204 may be located in a grocery store next to food items sold by a particular food manufacturer. Of course, digital sign 204 could be located in any other location.

In one example, analytics engine 214 may aggregate the number of positive messages related to a particular company and associated product. In another example, analytics engine 214 may identify a largest number of followers associated with a particular company, product, and/or service. In yet another example, analytics engine 214 may identify the total number of positive Twitter® messages (tweets) generated from a particular company account, such as an @acmelive account or referring to the @acmelive account, and the number of those Twitter® messages generated per minute. In yet other examples, analytics engine 214 may identify the number of likes for posts related to different products. Analytics engine 214 may generate any other metric that may indicate the aggregated social media popularity, engagement, volume, sentiment, etc. of a particular product or service.

In one example, analytics engine 214 may receive metrics 215 from third party data sources, such as Adobe® or Google® analytics that monitor, measure, and generate metrics for different data sources or web sites. In another example, analytics engine 214 may receive metrics 215 from customized databases, such as created by Salesforce®, Salesforce® Radian6, or Sysomos® that provide access to marketing and sales data.

As explained in copending application Ser. Nos. 15/160,694 and 14/997,013, social media 216 may include any message, tweet, picture, image, audio, video, text, posts, or any other data generated on any social media platform by any combination of users. Analytic engine 214 may generate social media metrics 215 based any combination of social media 216. Generating social media metrics 215 is known to those skilled in the art and is therefore not described in further detail.

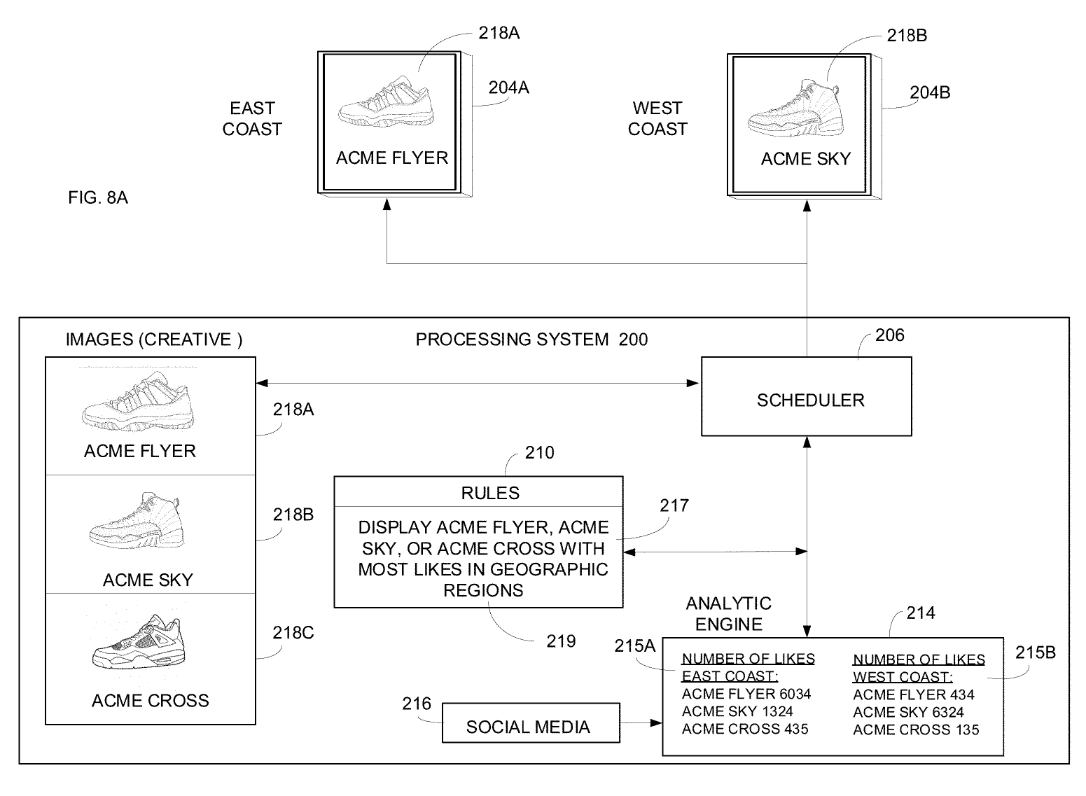

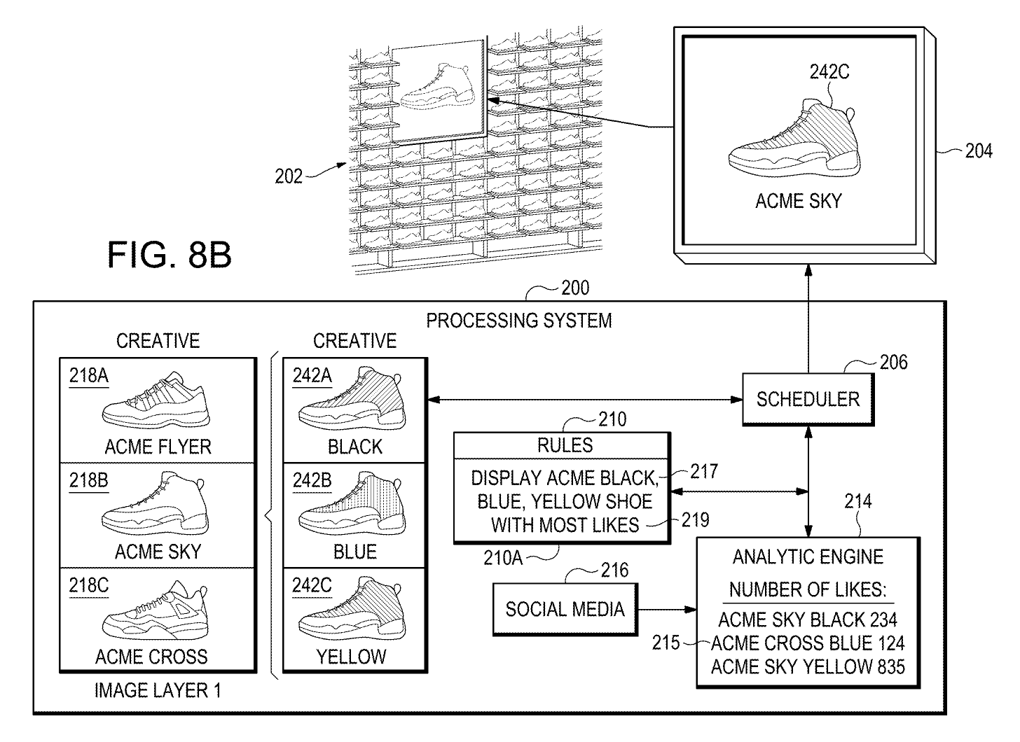

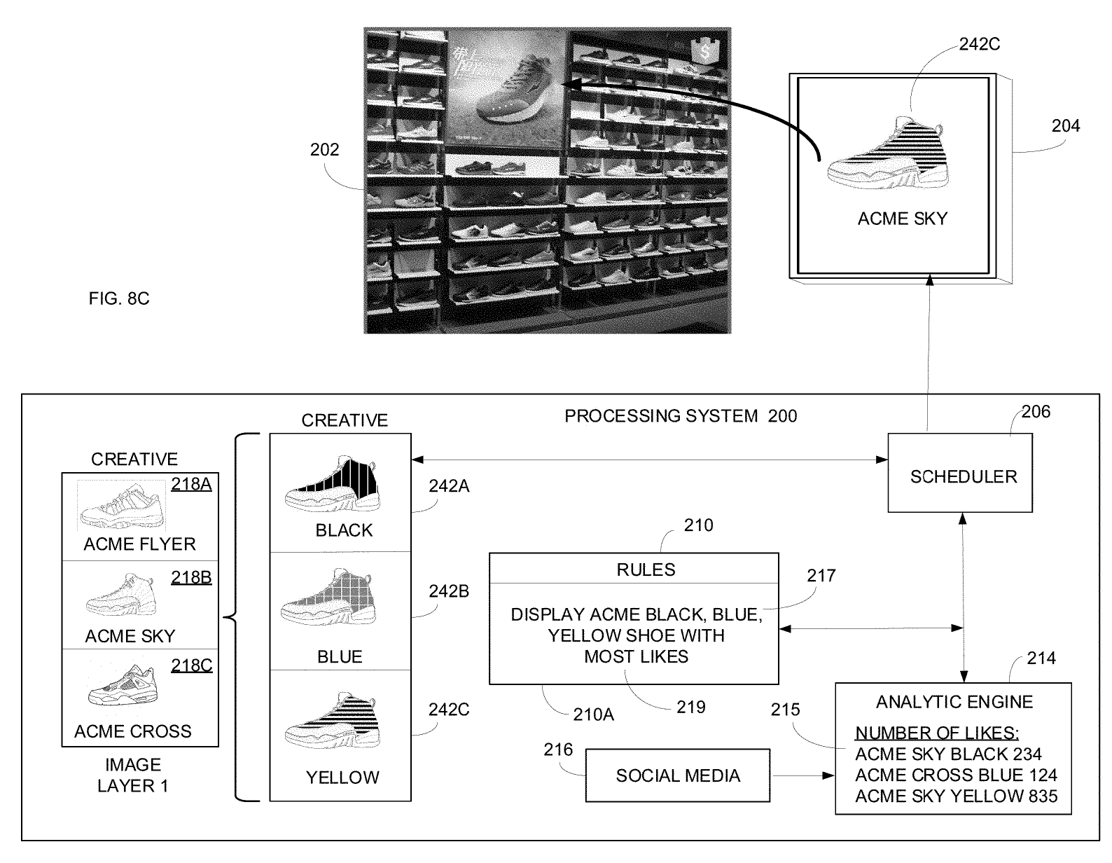

FIG. 8A shows another example where processing system 200 identifies and displays creative 218 based on social media metrics in different geographical regions. Digital signs 204 may be located in different geographic regions. For example, digital sign 204A may be located in a store on the East Coast of the United States and digital sign 204B may be located in a store on the West Coast of the United States. Social media metrics 215 may be different in different geographic regions.

An operator may create a rule 210 that directs scheduler 206 to display the creative for the most popular shoe on social media in each geographic region. For example, rule 210 may direct scheduler 206 to display creative 218 for the shoe with the most likes in each geographic region. Analytic engine 214 may generate metrics 215A for social media 216 generated on the East Coast and may generate metrics 215B for social media generated on the West Coast. East Coast metrics 215A may identify the Acme Flyer shoe as having the most likes and West Coast metrics 215B may identify the Acme Sky shoe as having the most likes.

Accordingly, scheduler 206 may send creative 218A for the Acme Flyer shoe to digital sign 204A located on the East Coast and may send creative 218B for the Acme Sky shoe to digital sign 204B located on the West Coast. Thus, regional digital signs 204A and 204B may display different creative 218 based on trending social media in those areas. Again, creative 218 may be displayed based on any social media metric 215, such as sentiment, volume, or engagement.

FIG. 8B shows another example where processing system 200 identifies and displays creative for a particular model, color, style, pattern or other distinguishing feature of a product. An advertising firm may generate multiple creative 242A-242C for different colors of the same product. Prior to launching a campaign, the shoe company and their associated advertising firm may have no idea which model, color, or style of a particular product may be the most popular.

Instead of guessing, the advertising firm may produce multiple layers of creative 218 and 242 that include different brands, models, styles, colors, features, etc. For example, another layer of creative may show each of the different shoe colors in either a high top version or a low top version.

An operator generates rules 210 directing scheduler 206 to determine which of the product models, styles, colors, features, etc. are most popular in social media 216. Scheduler 206 receives metrics 215 from analytic engine 214 that identifies the yellow Acme Sky as the most liked shoe. Accordingly, scheduler 206 sends creative 242C for the yellow Acme Sky shoe to digital sign 204.

In one example, processing system 200 may initially cycle through creative 218 and 242 for all shoe models and colors to determine which shoe model and color is most popular with customers in different geographic regions. Processing system 200 then displays one of creative 218 or 242 for the most popular shoe model and color indicated by metrics 215. Processing system 200 can be programmed for any number of creative to correspond with any combination of product models, styles, colors, features, etc. Creative 218 and 242 can be broken into different layers where each component of the creative is determined by a segmentation.

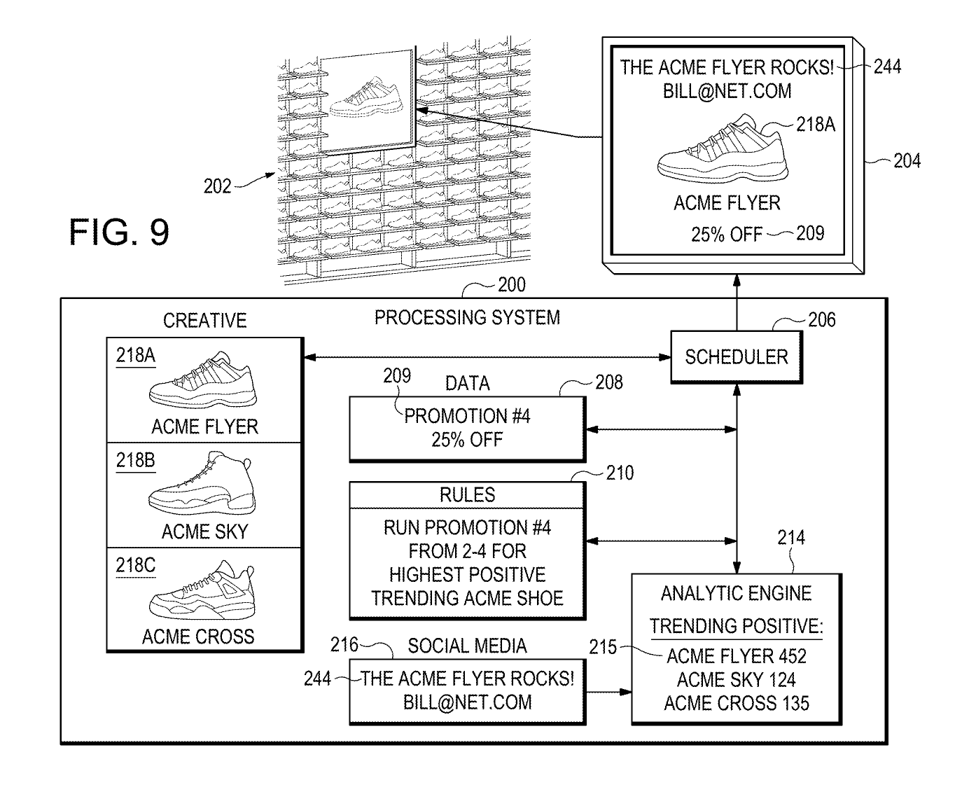

FIG. 9 shows another example where processing system 200 automatically displays promotions 209 based on metrics 215 derived from social media 216. An operator may store data 208 in processing system 200 that includes a promotion 209 or any other content that may be combined with creative 218. In this example, promotion 209 is for 25% off.

The business owner may determine that sales are slow between the hours of 2:00 pm-4:00 pm. To increase sales during this slow period, operator may create rule 210 that directs scheduler 206 to display promotion 209 for a highest trending Acme shoe between the hours of 2:00 pm-4:00 pm.

Scheduler 206 reads data 208 and rule 210 and identifies a highest trending Acme shoe for some designated time period, such as for the last week. In this example, metrics 215 identify the Acme Flyer shoe as the highest trending shoe. Based on rule 210, scheduler 206 displays creative 218A and promotion 209 between the hours of 2:00 pm and 4:00 pm on digital display 204. Thus, processing system 200 automatically generates promotions that may help increase sales for a particular product that may be trending on social media 216. Data 208 may include any other image, audio, text, or video that may be displayed based on social media 216 and/or rules 210.

Rules 210 also may direct scheduler 206 to display curated social media posts 244 with creative 218. For example, scheduler 206 may identify a positive post 244 regarding the highest trending Acme Flyer shoe. Scheduler 206 displays post 244 with Acme Flyer creative 218A to add an additional dimension of authenticity.

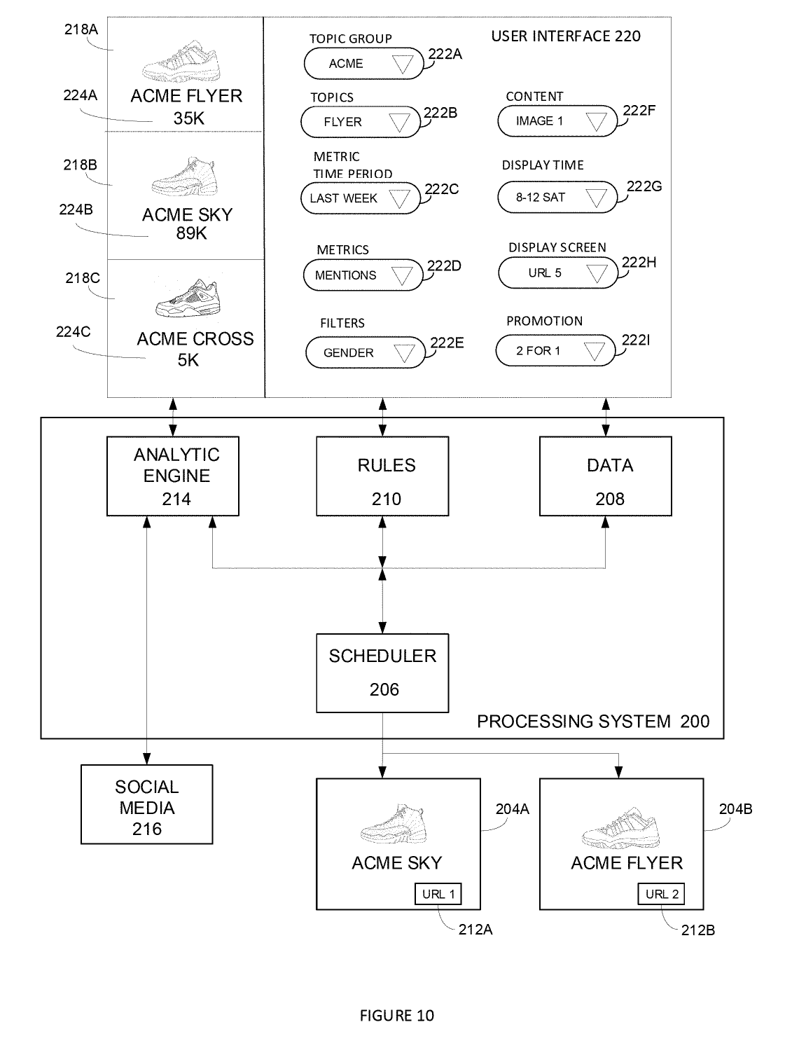

FIG. 10 shows an example user interface 220 that operates in conjunction with processing system 200. User interface 200 may include an array of control elements 222A-2221 that can control, program, and/or configure any combination of analytic engine 214, rules 210, scheduler 206, and data 208. In one example, control elements 222 may be a series of drop down menus. However, any mechanism can be used for entering data and programming processing system 200, such as any combination of control icons and fields.

The operator may select control element 222A to enter a group topic, such as a company or any other general category. The operator may select different topics associated with the topic group with control element 222B. For example, the operator may select different shoe models with control element 222B sold by the Acme company. Analytic engine 214 may extract social media 216 associated with the topic group and topic selected with control elements 222A and 222B, respectively.

The operator may select a metric time period with control element 222C associated with the identified topic. The metric time period may define the time window of social media used for generating associated metrics. For example, the operator may select a time period for a last week. Analytic engine 214 then may identify social media 216 generated during the last week that includes the topics selected with control elements 222A and 222B.

The operator may select a metric with control element 222D for the identified topic. For example, the operator may select a mentions metric with control element 222D. Analytic engine 214 then may identify which of the topics selected with control element 222B has the most positive mentions over the last week. Any of the metrics described above may be used for determining which associated creative 218 to display on digital sign 204. For example, metrics may be any social trend, volume, positive volume, sentiment, or engagement.

Social media 216 containing the topics may comprise posts, blogs, tweets, re-tweets, sentiment indicators, emails, text messages, videos, wall posts, comments, photos, links, or any other type of message or the like, or any combination thereof.

The operator may select different filters using control element 222E. For example, the operator may select a gender filter with control element 222E that directs analytic engine 214 to generate metrics from social media 216 generated by the selected gender. Any filter may be selected with control element 222E, including but not limited to, age, sex, demographic, geographical location, type of social media, or the like, or any combination thereof.

The operator may use control element 222F to select the different creative content 218 for displaying on digital signs 104. For example, the operator may select creative 218A for displaying with topics associated the Acme Flyer shoe, select creative 218B for displaying with topics associated the Acme Sky shoe, and select creative 218C for displaying with topics associated the Acme Cross shoe.

The operator may use control element 222G to select a display time for using a particular set of rules generated with control elements 222. The operator may select a first set of rules that include topics, metrics, filters, and associated creative for a first time period and select a second set of rules for a second time period.

For example, it may be determined that an older demographic visits shoe stores in the afternoon and a younger demographic visits shoe stores in the evening. The operator may create a first rule with a filter using only social media 216 generated by the older demographic and generate associated metrics for the older demographic during the afternoon hours. The first rule also may include creative 218 for products more commonly purchased by the older demographic or include creative 218 more appealing to the older demographic.

The operator may create a second rule with a filter using social media 216 generated by a younger demographic and generating associated metrics for the younger demographic during the evening hours. The second rule may include creative 218 for shoes more commonly purchased by the younger demographic or include creative 218 more appealing to the younger demographic.

The operator may use control element 222H to associate a particular set of rules with a particular digital sign 204. For example, each digital sign 204 may have an associated universal resource locator (URL). The operator may create a first set of rules 210 associated with a first digital sign 204A located on the West Coast. The first set of rules 210 may include filters directing analytic engine 214 to generate metrics from social media 216 generated by users on the West Coast of the United States. The operator may create a second set of rules 210 associated with a second digital sign 204B located on the East Coast. The second set of rules 210 may include filters directing analytic engine 214 to generate metrics from social media 216 generated by users on the east coast of the United States.

In another example, processing system 200 may automatically generate rules for different geographic regions. For example, an operator may generate a rule that directs scheduler 206 to display creative 218 associated with the shoe with a highest positive sentiment. Processing system 200 may automatically generate different filters 222E for display signs 204A and 204B in the different geographic regions. For example, processing system 200 may generate a first filter 222E for display signs 204A on the East Coast that only uses social media 216 generated on the East Coast and may automatically generate a second filter 222E for display signs 204B on the West Coast that only uses social media generated on the West Coast. Thus, the operator only has to create one rule 210 that automatically customizes/filters based on the geographic region where the associated digital display 204 is located.

The operator may use control element 222I to generate any other data associated with a particular set of rules 210 and/or creative 218. For example, the operator may create a promotion such as a 2 for 1 promotion for a particular time period when shoe sales are slow. Rules 210 may cause scheduler 206 to display the 2 for 1 promotion during the time period with slow shoe sales.

Processing system 200 also may display real-time metrics 224 associated with different topics and associated creative 218. For example, processing system 200 may display the number of mentions 224A, 224B, and 224C for each of the different Acme Flyer, Sky, and Cross shoes, respectively. This allows the operator to select and adjust rules 210 based on real-time customer feedback to different products.

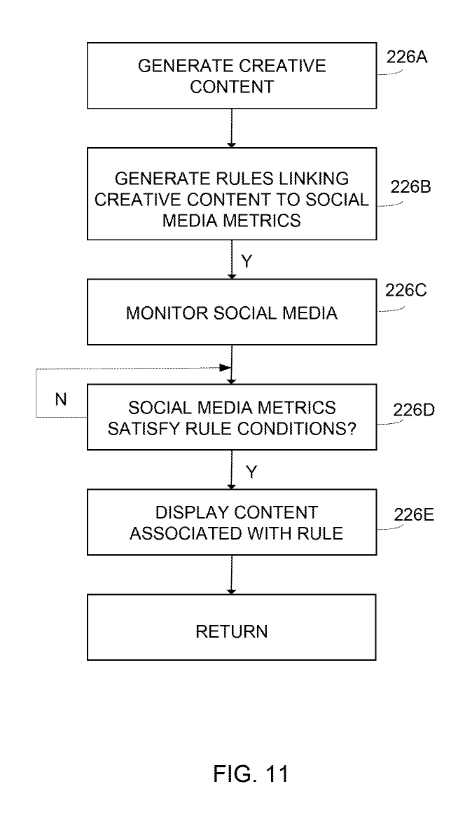

FIG. 11 is an example process performed by processing system 200. Referring to FIGS. 10 and 11, in operation 226A, processing system 200 generates creative content, such as images 218 for particular products or services. As mentioned above, creative 218 may include creative content created by an advertising firm, or any other media that may promote the sales of an associated product or service. In operation 226B, processing system 200 generates rules 210 linking the creative to different social media metrics. As explained above, the rules may direct processing system 200 to display a particular creative, image, promotion, etc. when an associated topic produces a particular metric in the social media.

In operation 226C, processing system 200 monitors social media 216. For example, analytic engine 214 generates metrics for particular topics in social media 216. In operation 226D, processing system 200 determines if the social media metrics satisfy conditions of rules 210 that trigger the display of creative. For example, rules 210 may direct processing system 200 to display different creative for topics having a highest aggregated social media metric, such as a shoe with the largest number of likes. In operation 226E, processing system 200 displays the creative associated with the topic with the highest metric.

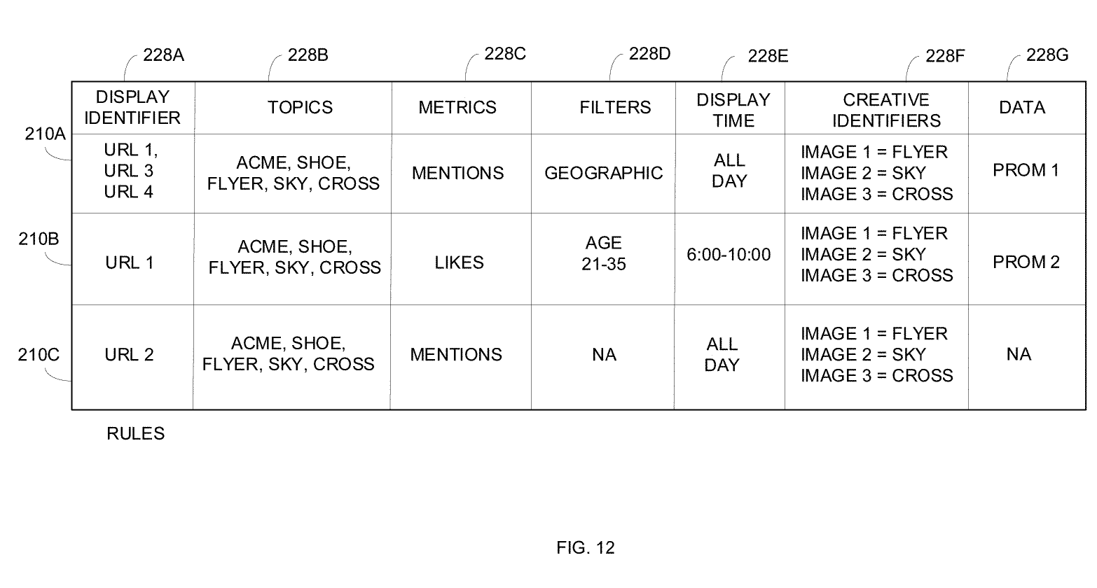

FIG. 12 shows some example rules generated by processing system 200. This example shows three different rules 210A, 210B, and 210C. Each rule 210 may have an associated display identifier 228A. For example, rule 210A may be associated with three digital signs having a URL 1, URL 3, and URL 4. Rule 210B may be associated with the digital sign having URL 1, and rule 210C may be associated with a digital sign having URL 2.

Each rule 210 may have an associated set of topics 228B. In this example, rules 210 are all associated with the same set of topics that identify the three different Acme shoes. Each rule 210 also may have associated metric identifiers 228C. For example, rules 210A and 210C may have metric 228C for a largest number of positive mentions and rule 210B may have a metric for a largest number of likes.

Each rule 210 may have associated filters 228D. In this example, rule 210A has a filter 228D directing the analytic engine to use social media associated with the geographic region of the digital sign. For example, if URL 1 is located on the East Coast, the scheduler would only use metrics from social media generated on the East Coast to identify the Acme shoe with the largest number of mentions. If URL 3 is located in Spain, the scheduler would only use metrics from social media generated in Spain to identify the Acme shoe with the largest number of mentions.

Rule 210B has a filter 228D directing the scheduler to only use social media generated by users between the ages of 21-34 when identifying the Acme shoe with the largest number of likes.

A display time 228E may indicate when the processing system displays the content associated with rule 210. For example, rules 210A and 210C may be used all day and rule 210B may only be used between the hours of 6 pm-10 pm.

Creative identifiers 228F may identify the creative images associated with different topics 228B. For example, each rule 210 includes three creative images associated with the three topics Acme Flyer, Acme Sky, and Acme Cross. Of course other images could be associated with any combination of rules 210 and topics.

Data 228G may associate any other content or parameter with rules 210. As explained above, different promotions may be associated with different rules 210. Any other parameter or condition can also be added to any rule 210 as described above in FIG. 10.

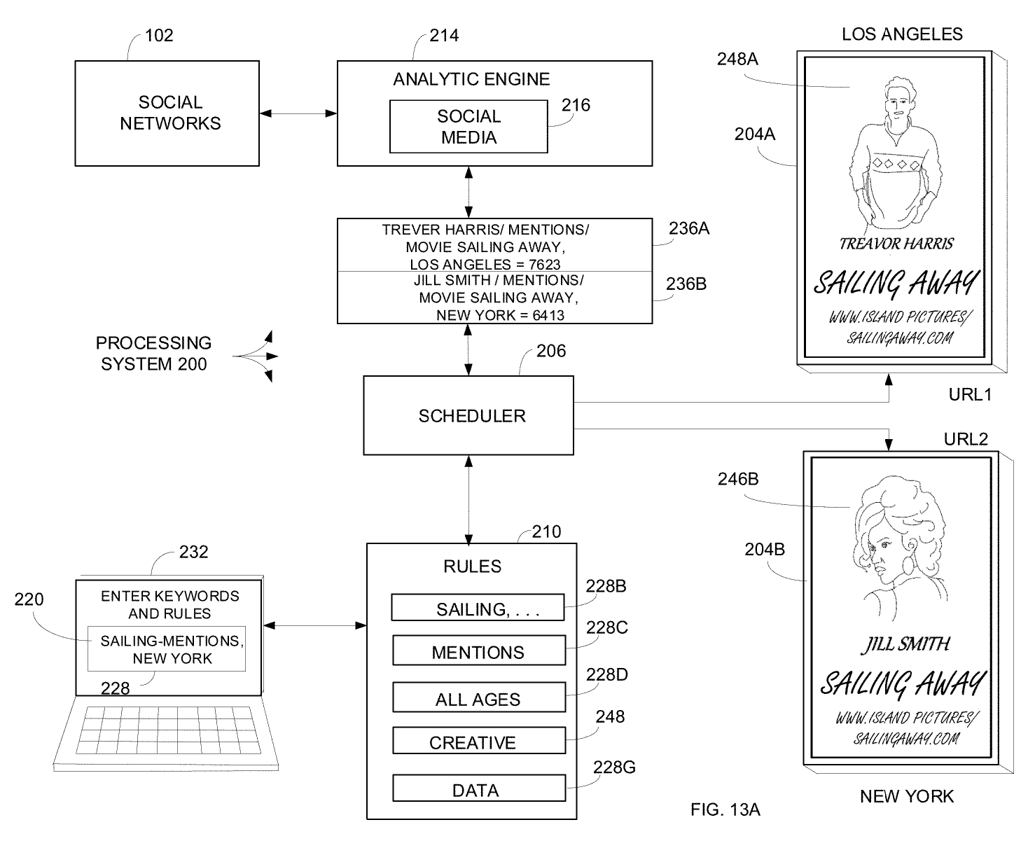

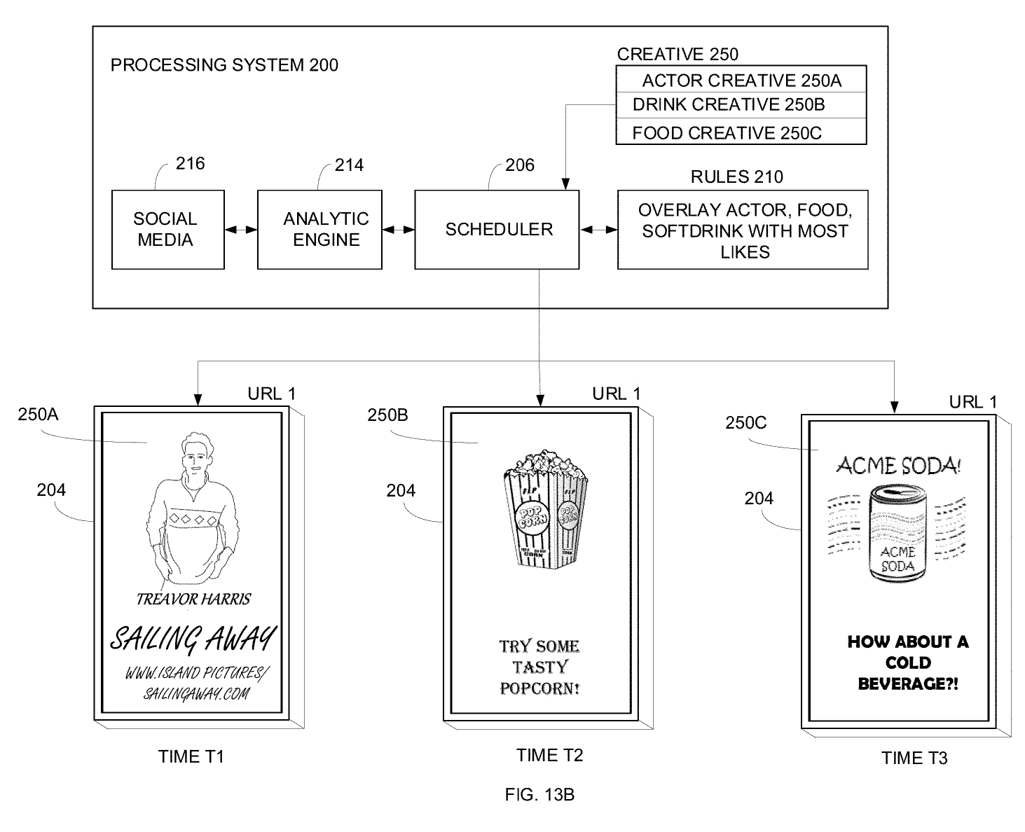

FIG. 13A shows another example of how the processing system curates creative content based on social media metrics. In this example, processing system 200 displays different content on movie bill boards based on social media. In this example, a movie entitled Sailing Away is being shown at different movie theaters around the country. The two main actors in the movie are Trever Harris and Jill Smith. The movie studio would like to increase movie ticket sales by promoting the actor most popular with audiences.

Typically, the movie studio creates multiple posters that each promote a different actor or promote different combinations of actors. However, the movie studio may not know which actor, or which character played by the actor, will be most popular with audiences. Further, different actors may be more popular with different age groups or more popular with audiences in different cities.

The operator may enter parameters 228 for rules 210 into user interface 220 operated on a computer 232 as described above. Rules 210 may include keywords or topics 228B that include the name of the movie and the name of the actors in the movie. Rule 210 also may include metrics 228B that direct analytic engine 214 to identify the number of positive mentions for each of the different actors in the Sailing Away movie. Rule 210 also may include filters 228C that in this example direct analytic engine 214 to identify the number of positive mentions for all age groups. Rule 210 also may identify the creative 248 associated with each actor and any other data 228G displayed in conjunction with creative 248.

Analytic engine 214 extracts social media 216 from any combination of social networks 102 and generates metrics 236 identified by rule 210. In this example, analytic engine 214 determines that Trevor Harris generates the most positive mentions for the movie Sailing Away in Los Angeles and Jill Smith generates the most mentions for the movie Sailing Away in New York.

Rule 210 directs scheduler 206 to display creative 248 for the actor with the most positive mentions in Los Angeles on digital sign 204A and display creative 248 for the actor with the most mentions in New York on digital sign 204B. Accordingly, scheduler 206 displays creative 248A for Trevor Harris on digital sign 204A and displays creative 248B for Jill Smith on digital sign 204B.

If metrics 236A and 236B change over some specified time period in either Los Angeles or New York, scheduler 206 may automatically update creative 248A and/or 248B with the creative of the new actor with the most mentions.

As also described above, rules 210 may include different filters and time periods. For example, older customers may attend matinees in the afternoon. The operator may create a filter that causes analytic engine 214 to generate metrics 236 for users above the age of 50. Scheduler 206 then may display the creative 248 for the actors with the most mentions by users above the age of 50 between the hours of 12:00 pm-5:00 pm. Of course any other filter or time period also may be programmed into rules 210.

FIG. 13B shows how processing system 200 overlays multiple creative 250 based on social media metrics. An operator may store different groups of creative images 250 in processing system 200. In this example, a first group of creative 250A may include actors in the movie Sailing Away, a second group of creative 250B may include drink products sold at the movie theater showing the movie Sailing Away, and a third group of creative 250C may include food products sold at the movie theater showing the movie Sailing Away.

In this example, rules 210 direct scheduler 206 to interlay actor creative 250A, drink creative 250B, and food creative 250C based on related social media metrics. For example, scheduler 206 first may identify one of the actors in the movie Sailing Away with the most likes in social media 216. In this example, scheduler displays creative 250A for Trevor Harris on digital sign 204 for a predetermined time period T1.

Rules 210 also directs scheduler 206 to automatically overlay a second drink creative 250C over actor creative 250A. Scheduler 206 identifies one of a list of drink products sold by the theater with the most likes and displays the associated creative 250B on digital sign 204 for a time period T2.

Rules 210 then directs scheduler 206 to automatically overlay a third food creative 250C over drink creative 250B. Scheduler 206 identifies one of a list of food products sold by the theater with the most likes and overlays the associated creative 250C on digital sign 204 for a time period T3. Rules 210 may direct scheduler 206 to repeat the display process by then overlaying an actor creative 250A with the most likes.

The social media based overlays in FIG. 13B can be used for any combination of items. For example, a restaurant may serve breakfast, lunch, and dinner items. An operator may include three sets of creative 250A, 250B, and 250C associated with breakfast, lunch, and dinner items, respectively. Rules 210 may direct scheduler 206 to display one or more breakfast creative 250A associated with a breakfast product with highest social media metric during a first time period associated with breakfast, display one or more lunch creative 250B associated with a lunch product with a highest social media metric during a second time period associated with lunch, and display one or more creative 250C associated with a dinner product with a highest social metric during a third time period associated with dinner.

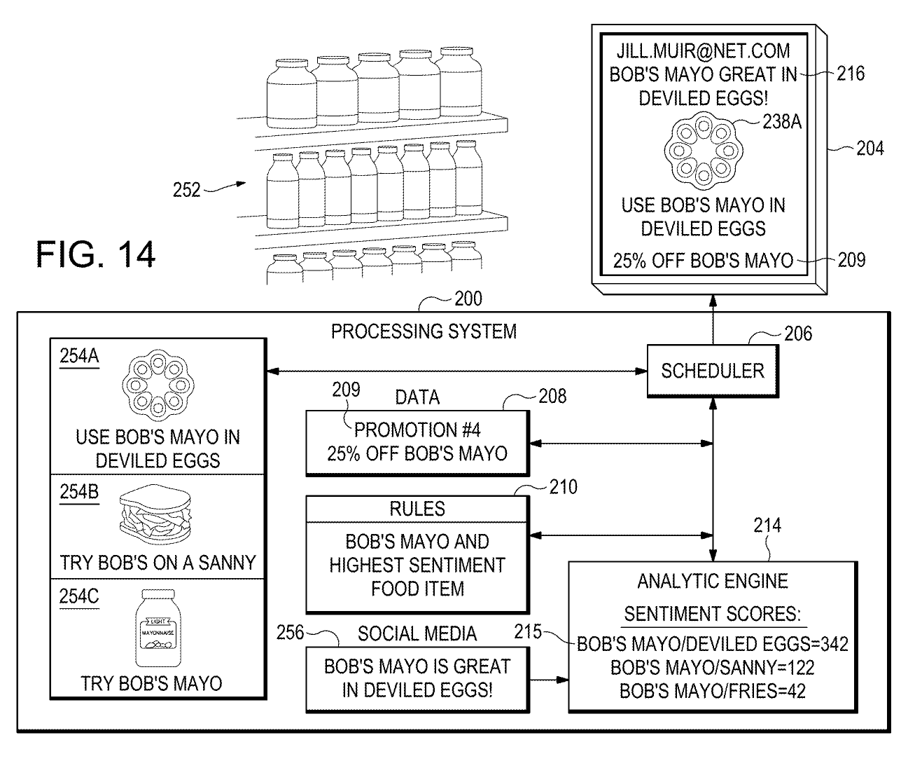

FIG. 14 shows another example of how processing system 200 may automatically generate different promotions. A manufacturer may sell mayonnaise products on shelves 252 of a grocery store. Digital display 204 may be located adjacent to shelves 252. An advertising team may generate a series of creative images 254 showing mayonnaise used with different food products. For example, creative 254A may show the mayonnaise used with deviled eggs and creative 254B may show the mayonnaise used on a sandwich. A third creative 254C may show a generic picture of a mayonnaise container.

An operator may generate a set of rules 210 that direct processing system 200 to display different creative 254 based on social media metrics. For example, rules 210 may direct analytic engine 214 to aggregate social media that refers to food items and the manufacturers mayonnaise. Rules 210 also direct scheduler 206 to display data 208 that contains a 20% off promotion 209.

Based on rules 210, analytic engine 214 generates metrics from social media 216 referring to food items in conjunction with the manufacturer's mayonnaise. Analytic engine 214 also identifies which of the food items has a highest sentiment metric 215. In this example, analytic engine 214 identifies deviled eggs as having a highest social media sentiment 215.

Rules 210 associate creative 254A with the topic deviled eggs. Scheduler 206 then displays creative 254A on digital sign 204 that shows the mayonnaise being used with deviled eggs. Rules 210 also may direct scheduler 206 to display a promotion 209 that offers 25% off the mayonnaise. As explained above, promotion 209 may be displayed for a particular time period, location, or any other condition.

Rules 210 also may direct scheduler 206 to display social media messages 256 associated with the highest sentiment food item. As explained above, displaying social media messages 256 may provide more customer interest in the creative 254 displayed on digital sign 204.

Social media sentiments for different food items may change based on the time of year or time of day. Processing system 200 automatically changes creative 254 based on the food item with the current highest sentiment. Advertisers can then create a series of creative advertisements 254 and allow processing system 200 to select the particular advertisement 254 most appealing to consumers.

### Hardware and Software

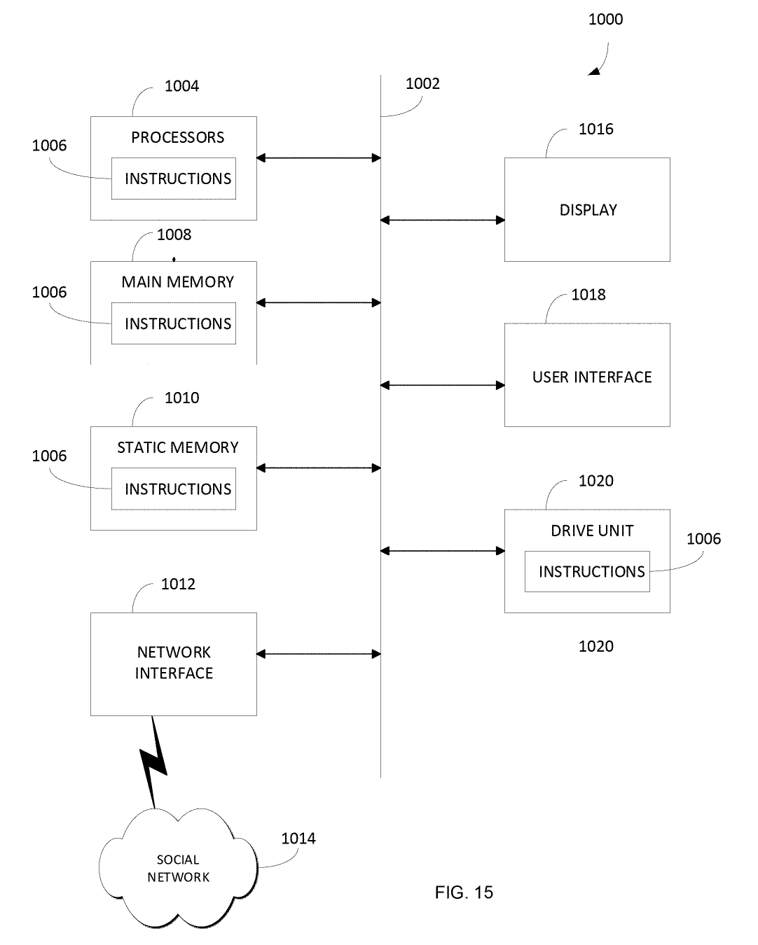

FIG. 15 shows a computing device 1000 that may be used for operating processing system 200 and performing any combination of processes discussed above. The computing device 1000 may operate in the capacity of a server or a client machine in a server-client network environment, or as a peer machine in a peer-to-peer (or distributed) network environment. In other examples, computing device 1000 may be a personal computer (PC), a tablet, a Personal Digital Assistant (PDA), a cellular telephone, a smart phone, a web appliance, or any other machine or device capable of executing instructions 1006 (sequential or otherwise) that specify actions to be taken by that machine.

While only a single computing device 1000 is shown, the computing device 1000 may include any collection of devices or circuitry that individually or jointly execute a set (or multiple sets) of instructions to perform any one or more of the operations discussed above. Computing device 1000 may be part of an integrated control system or system manager, or may be provided as a portable electronic device configured to interface with a networked system either locally or remotely via wireless transmission.

Processors 1004 may comprise a central processing unit (CPU), a graphics processing unit (GPU), programmable logic devices, dedicated processor systems, micro controllers, or microprocessors that may perform some or all of the operations described above. Processors 1004 may also include, but may not be limited to, an analog processor, a digital processor, a microprocessor, multi-core processor, processor array, network processor, etc.

Some of the operations described above may be implemented in software and other operations may be implemented in hardware. One or more of the operations, processes, or methods described herein may be performed by an apparatus, device, or system similar to those as described herein and with reference to the illustrated figures.

Processors 1004 may execute instructions or “code” 1006 stored in any one of memories 1008, 1010, or 1020. The memories may store data as well. Instructions 1006 and data can also be transmitted or received over a network 1014 via a network interface device 1012 utilizing any one of a number of well-known transfer protocols.

Memories 1008, 1010, and 1020 may be integrated together with processing device 1000, for example RAM or FLASH memory disposed within an integrated circuit microprocessor or the like. In other examples, the memory may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

“Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop, wireless device, or even a laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

Computing device 1000 can further include a video display 1016, such as a liquid crystal display (LCD) or a cathode ray tube (CRT)) and a user interface 1018, such as a keyboard, mouse, touch screen, etc. All of the components of computing device 1000 may be connected together via a bus 1002 and/or network.

For the sake of convenience, operations may be described as various interconnected or coupled functional blocks or diagrams. However, there may be cases where these functional blocks or diagrams may be equivalently aggregated into a single logic device, program or operation with unclear boundaries.

Having described and illustrated the principles of a preferred embodiment, it should be apparent that the embodiments may be modified in arrangement and detail without departing from such principles. Claim is made to all modifications and variation coming within the spirit and scope of the following claims.

1. A computer program stored on a non-transitory storage medium, the computer program comprising a set of instructions, when executed by a hardware processor, cause the hardware processor to:
store a set of creative images associated with different subjects;
store rules specifying conditions for displaying the creative images based on social media metrics for the subjects;
monitor the social media metrics for the subjects;
identify subjects with social media metrics satisfying the conditions; and
display the creative images associated with the identified subjects on digital signs.

2. The computer program of claim 1, wherein the rules identify:
topics describing the subjects;
social media metrics for the topics; and
which creative images to display for the subjects.

3. The computer program of claim 1, wherein the rules include a time period of the social media to use for generating the social media metrics.

4. The computer program of claim 1, wherein the rules include filters identifying different demographics of the social media to use for the metrics.

5. The computer program of claim 5, wherein the rules include time periods for displaying the creative images.

6. The computer program of claim 1, wherein the rules include universal resource locators (URLs) identifying the digital signs for displaying the creative images.

7. The computer program of claim 1, wherein the rules identify promotional data to display along with the creative images.

8. The computer program of claim 1, wherein:
the creative images include multiple layers showing different characteristics of the subjects;
the rules include topics that refer to the different characteristics of the subjects; and
the instructions when executed by the processor are configured to:
detect the characteristics of the subjects with the highest social media metrics; and
display the creative images that show the characteristics of the subjects with the highest social media metrics.

9. The computer program of claim 1, wherein the instructions when executed by the processor are configured to:
identify the subjects having the highest social media metrics for different geographic regions;
identify the creative images associated with the identified subjects; and
display the creative images on the digital signs in the geographic regions where the associated subjects have the highest social media metrics.

10. The computer program of claim 1, wherein the instructions when executed by the processor are configured to:
identify promotional data associated with the rules; and
display the promotional data on the digital signs with the creative images.

11. The computer program of claim 1, wherein the instructions when executed by the processor are configured to:
identify posts in the social media associated with the identified subjects; and
display the posts on the digital sign with the creative images associated with the identified subjects.

12. A processing system for displaying content on a digital sign based on social media metrics, comprising:
a processing device configured to:
identify keywords for identifying in the social media;
identify one or more metrics for the social media including the keywords;
identify creative images associated with the keywords; and
display the creative images based on the metrics for the associated keywords.

13. The processing system of claim 12, wherein the processing device is further configured to operate a user interface for receiving rule parameters that identify the keywords, metrics, and creative images.

14. The processing system of claim 13, wherein the processing device is further configured to receive a time period and identify the metrics for the received time period.

15. The processing system of claim 12, wherein the processing device is further configured to receive a filter, and identify the metrics for the social media associated with the filter.

16. The processing system of claim 15, wherein the filter identifies a demographic or geographic location, and the processing device is configured to identify the metrics for the social media associated with the demographic or geographic location.

17. The processing system of claim 12, wherein the processing device is further configured to:
receive an operation time period; and
display the creative images based on the metrics for the associated keywords during the operation time period.

18. The processing system of claim 12, wherein the processing device is further configured to:
receive a universal resource locator (URL); and
display the creative images on a digital sign associated with the URL.

19. The processing system of claim 12, wherein the processing device is further configured to:
store promotional data; and
display the promotion data with the creative images.

20. A computer program stored on a non-transitory storage medium, the computer program comprising a set of instructions, when executed by a hardware processor, cause the hardware processor to:
store a set of advertising images;
store a set of rules associating keywords with the advertising images;
identify metrics for social media including the keywords; and
display the advertising images on a digital sign based on the metrics for the social media including the keywords.

21. The computer program of claim 20, wherein the set of instructions, when executed by a hardware processor, further cause the hardware processor to:
store multiple advertising images for different versions of a same product;
identify in the social media one of the versions of the product with the highest metrics in the social media; and
display the advertising image for the version of the product with the highest metrics.

22. The computer program of claim 20, wherein the set of instructions, when executed by a hardware processor, further cause the hardware processor to:
store multiple advertising images for different products produced by a same manufacturer;
identify in the social media one of the products with the highest metrics in the social media; and
display one of the advertising images for the identified product.

23. The computer program of claim 20, wherein the set of instructions, when executed by a hardware processor, further cause the hardware processor to:
store different advertising images of different actors acting in a same movie;
identify metrics in the social media about the actors acting in the movie; and
display one of the advertising images for one the actors with the highest metrics in the social media.

24. The computer program of claim 20, wherein the set of instructions, when executed by a hardware processor, further cause the hardware processor to:
store different advertising images of a product used in combination with different items;
identify metrics in the social media about the product used in combination with the different items; and
display one of the advertising images associated with the product and one of the different items with the highest social media metrics.
